(19) United States
(12) Patent Application Publication
(10) Pub. No.: US 2012/0104718 A1
(43) Pub. Date: May 3, 2012

(54) TUBULAR SIDE BAR AND MOUNTING SYSTEM

(76) Inventors: Manuel Alvarez, Zapopan (MX); Rigoberto Gonzalez, Zapopan (MX); Alberto Montoya, Guadalajara (MX); Felipe Ceja, Zapopan (MX)

(21) Appl. No.: 12/916,069

(22) Filed: Oct. 29, 2010

(51) Int. Cl. B60R 3/00; B23P 11/00; F16M 13/02

(52) U.S. Cl. 280/163; 248/201; 29/428

(57) ABSTRACT

A tubular side bar and mounting system may have a plurality of separate components that allow the tubular side bar to be mounted to a truck or other vehicle by one person. The system may include one or more mounting brackets that can be mounted to the truck before mounting a tubular side bar. After the mounting brackets are secured to the truck, the tubular side bar is then mounted to the mounting brackets. In this manner, a single person may install the tubular side bar to the truck. To attach the mounting bracket to the tubular side bar, the mounting bracket may be clamped along any point of an elongate channel formed in the tubular side bar to account for trucks with different mounting places. One configuration of the running board can be mounted to different trucks having different mounting places configuration.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a running board for a truck.

Current aftermarket running boards are typically mounted to a raised truck to provide an intermediate step to assist the driver and passengers in entering and exiting the truck. For installation purposes, the mounting brackets of the running boards are matched to the existing mounting hole pattern of the particular truck. These mounting hole patterns on the truck are typically designed by the original equipment manufacturer (OEM) for the purposes of mounting the OEM running board. However, some consumers prefer aftermarket running boards instead of the OEM running board. As such, the aftermarket running board must match the mounting pattern established by the OEM vehicle manufacturer.

To mount the aftermarket running board to the truck, the aftermarket running board must have mounting brackets that match exactly to the mounting hole pattern of the truck. Any deviation is not allowed since such deviation would prohibit attachment of the mounting bracket of the aftermarket running board to the truck. Unfortunately, this causes the aftermarket running board manufacturer to stock one configuration of the aftermarket running board for each model of truck in the marketplace having a different hole pattern. For any variation, a different running board configuration must be established, manufactured, stored, and sold thereby increasing the work and costs involved in providing aftermarket running boards.

Aftermarket running boards are also difficult to install. Aftermarket running boards typically require two people to install. The running board must be lifted in place so that the mounting brackets are aligned to the mounting hole pattern on the truck. As one person holds the running board in place, the second person attaches the mounting brackets to the truck either by way of bolts or other attachment means provided by the aftermarket running board manufacturer.

Accordingly, based on the foregoing discussion there is a need in the art for an improved aftermarket running board.

### BRIEF SUMMARY

The system described herein addresses the needs discussed above, discussed below, and those that are known in the art.

The running board system disclosed herein relates to a tubular side bar mounting system that allows for versatility, ease of install, and compact shipping. The tubular side bar mounting system includes a running board that can be mounted to a truck. The running board has one or more mounting brackets (preferably at least two) that can be individually mounted to the truck first. The mounting brackets are individual pieces and can be easily mounted by one person one at a time. After all of the mounting brackets are secured to the truck, a tubular side bar (i.e., step) is then mounted to the mounting brackets. To this end, the tubular side bar has an elongate channel so that the mounting brackets can be spaced apart differently as dictated by the mounting hole pattern of the truck yet securable to the tubular side bar. The tubular side bar mounting system disclosed herein is versatile in that one configuration can be mounted to multiple models of trucks. To mount the tubular side bar to the mounting brackets, the mounting brackets clamp onto medial edge portions of the tubular side bar that define the channel of the tubular side bar. This system is componentized and allows the running board to be shipped in a compact configuration. The mounting brackets may be removed from the tubular side bar when being shipped to a customer or retail outlet for stacking and then installed on the truck after shipment by one person.

More particularly, a system for mounting a running board to a vehicle is disclosed. The running board may comprise a tubular side bar, first and second mounting brackets, and fasteners. The tubular side bar may have a single elongate channel located at an underside of the tubular side bar. The tubular side bar may have medial edge portions that define the single elongate channel. First and second mounting brackets may be attached to mounting places on the vehicle. The first and second mounting brackets may have support pads that define support surfaces that can be aligned to any point along the elongate channel. First and second retaining plates may be inserted into an interior of the tubular side bar with the medial edge portions disposed between first and second retaining plates and the support pads of the first and second mounting brackets. The fasteners may be attached to the first and second retaining plates and the first and second mounting brackets by way of the single elongate channel for clamping the medial edge portions of the tubular side bar between the first and second retaining plates and the support pads of the first and second mounting brackets. The running board can be mounted to trucks with mounting places having different distances since the first and second mounting brackets can be mounted at different mounting points along the single elongate channel of the tubular side bar.

The running board may have end caps attached to opposed distal ends of the tubular side bar. The fasteners may be bolts. The support pads may have through holes aligned to threaded holes formed in the retaining plate and aligned to the single elongate channel so that bolts may be fed through the through holes, through the single elongate channel and threadingly engage the threaded holes of the retaining plate.

Additionally, a running board for a vehicle is disclosed. The running board may comprise a tubular side bar and first and second mounting brackets. An underside of the tubular side bar may have an elongate channel for accessing an interior of the tubular side bar. First and second mounting brackets may be attached to mounting places of the vehicle. The first mounting bracket may be attached to tubular side bar. The second mounting bracket can also be attached to the tubular side bar along the elongate channel so that a first distance between attachment points of the first and second mounting brackets to the tubular side bar corresponds to a second distance between the mounting places of the vehicle when the running board is mounted to the vehicle. The running board can be mounted to trucks having different second distances defined by the mounting places since the first and second mounting brackets can be mounted at different mounting points along the single elongate channel of the tubular side bar.

The running board may further comprise a retaining plate attachable to the second mounting bracket wherein medial edge portions that define the elongate channel are disposed between the second mounting bracket and the retaining plate for securing the tubular side bar to the second mounting bracket. The retaining plate may be disposed within the interior of the tubular side bar. The running board further comprises a bolt for securing the retaining plate to the second mounting bracket.

The second mounting bracket may further comprise a support surface and the bolt clamps the medial edge portions between the support surface and the retaining plate to frictional engage the tubular side bar to the second mounting bracket. The first mounting bracket is attachable to the tubular side bar along the elongate channel.

The running board may further comprise first and second retaining plates which are attachable to the first and second mounting brackets. The medial edge portions of the tubular side bar are disposed between the first and second mounting brackets and the first and second retaining plates for securing the tubular side bar to the first and second mounting brackets.

The first and second mounting brackets may further comprises first and second support surfaces and medial edge portions that define the channel of the tubular side bar may be disposed between the first and second retaining plates and the first and second support surfaces wherein first and second bolts clamp the medial edge portions between the first and second support surfaces and the first and second retaining plates to frictional engage the tubular side bar to the first and second mounting brackets.

The first and second support surfaces may have recesses for receiving a reversed lip of the medial edge portion. Alternatively or additionally, the first and second retaining plates may have recesses for receiving a reversed lip of the medial edge portion

The running board may further comprising friction pads secured to an upperside of the tubular side bar.

Additionally, a method of mounting a running board to a vehicle is disclosed. The method may comprise the steps of attaching first and second mounting brackets to mounting places on the vehicle; laying a tubular side bar on support surfaces of the first and second mounting brackets wherein the support surfaces are aligned along an elongate channel of the tubular side bar; inserting retaining plates within an interior of the tubular side bar; aligning the retaining plates to the support surfaces of the first and second mounting brackets; and clamping medial edge portions of the tubular side bar that define an elongate channel of the tubular side bar between the retaining plates and the support surfaces of the first and second mounting brackets to attach the tubular side bar to the first and second mounting brackets.

The clamping step may comprise the step of bolting the first and second mounting brackets to the retaining plate.

In the method, the elongate channel may comprise first and second elongate channels spaced apart to correspond to a distance between mounting places on the vehicle.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a running board mountable to a vehicle;

FIG. 2 is a bottom view of a tubular side bar of the running board shown in FIG. 1 with a single elongate channel;

FIG. 2A is an alternate embodiment of the tubular side bar with a plurality of elongate channels;

FIG. 3 is a cross sectional view of the tubular side bar shown in FIG. 1 illustrating attachment of a mounting bracket to the tubular side bar;

FIG. 3A is an alternate embodiment showing a recess in a retaining plate for capturing a lip of the tubular side bar;

FIG. 3B is a further alternate embodiment showing a recess in a support surface of the mounting bracket for capturing a lip of the tubular side bar;

FIG. 4 is an exploded perspective view of FIG. 3;

FIG. 5 is an assembled perspective view of FIG. 3.

### DETAILED DESCRIPTION

Referring now to the drawings, a running board 10 that can be mounted to a side of a truck 12 is shown. The running board 10 has an elongate tubular side bar 14 that has an elongate channel 15 that may run along an entire length of the tubular side bar 14. Mounting brackets 16 may be secured to mounting places 18 located on the side of the truck 12. The location of the mounting places 18 on the side of the truck 12 may vary from one vehicle manufacturer to another vehicle manufacturer as well as on truck model to the next. Nonetheless, regardless of the location of the mounting places 18 on the truck along an X-axis 20, the mounting brackets 16 may be secured to the tubular side bar 14 since the elongate channel 15 of the tubular side bar 14 allows the mounting brackets 16 to be located at various distances from each other. The running board 10 provides for a more universal system so that one configuration of the running board 10 can fit a greater number of truck models compared to the prior art running board. Moreover, the running board 10 disclosed herein allows one person to mount the running board 10 by first mounting the mounting brackets 16 to the truck 12 then resting the tubular side bar 14 on the mounting brackets 16 and securing the tubular side bar 14 to the mounting brackets 16. The running board 10 disclosed herein also provides for a compact disassembled configuration since the mounting brackets 16 can be removed from the elongate tubular side bar 14 and stacked upon each other thereby providing for convenient shipping.

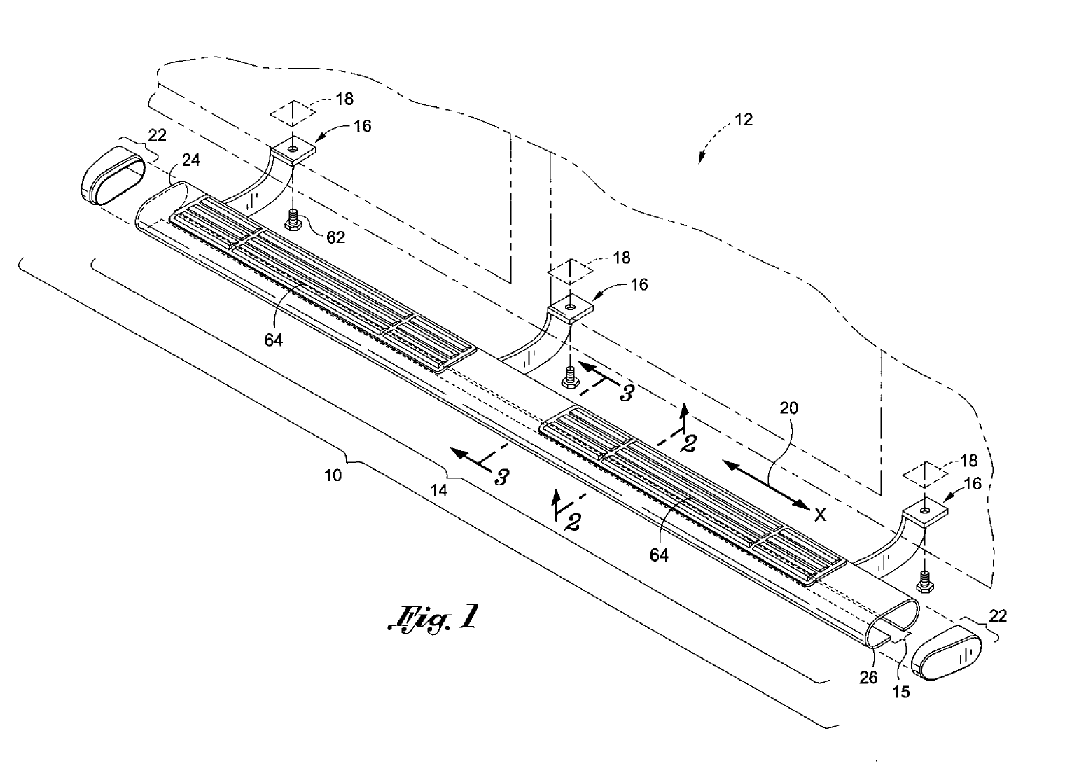

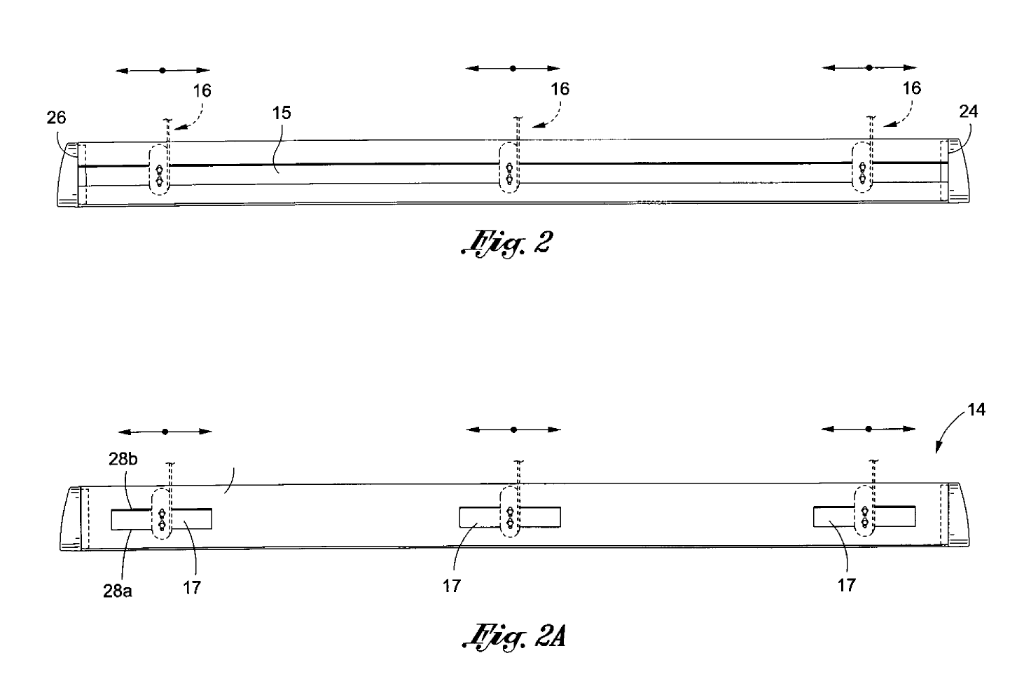

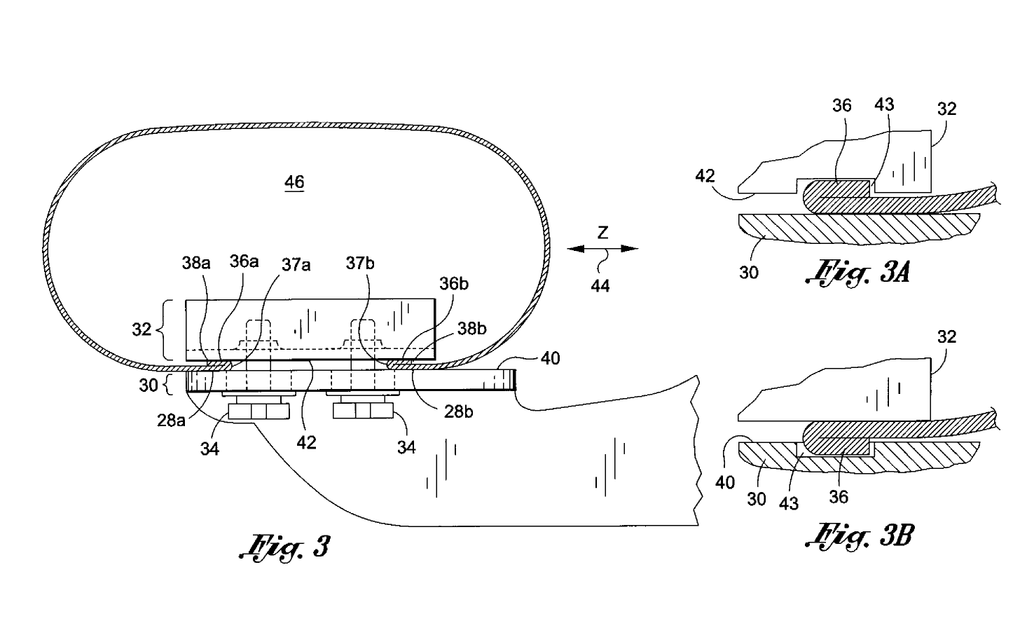

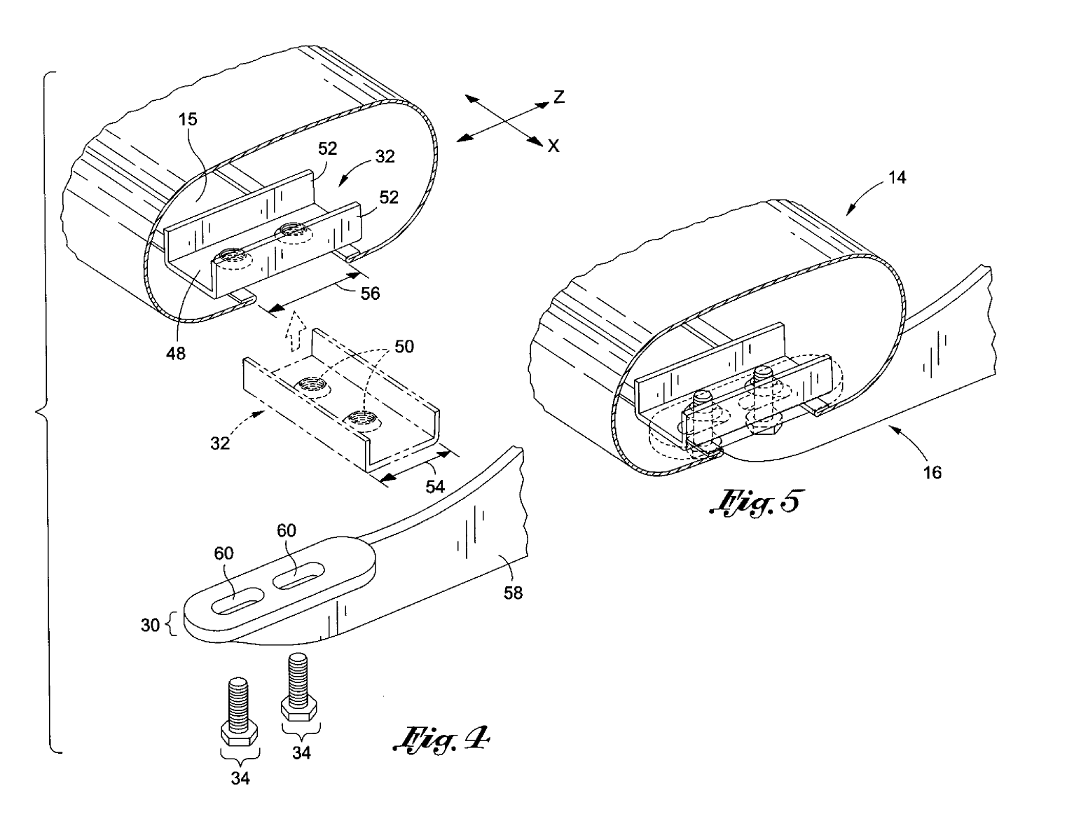

More particularly, referring now to FIG. 1, the running board 10 may include the tubular side bar 14, mounting brackets 16, and end caps 22. The tubular side bar 14 may have an elongate configuration. The tubular side bar 14 may be fabricated with a press brake or through a roll forming process. It is also contemplated that the tubular side bar 14 can also be extruded. Also, the tubular side bar 14 may also have an oval cross sectional shape as shown in FIGS. 1 and 3. Although an oval shape is shown, other cross sectional configurations are also contemplated such as circular, triangular, rectangular, etc. The channel 15 of the tubular side bar 14 may extend from a first end 24 to a second end 26 as a single elongate channel 15 as shown in FIG. 2. The elongate channel 15 may be defined by medial edge portions 28a, 28b as shown in FIG. 3. These medial edge portions 28a, 28b may be flat and within the same plane. The medial edge portions 28a, 28b may be clamped between a support plate 30 (see FIG. 3) and a retaining plate 32 by way of bolts 34. The medial edge portions 28a, 28b may also have optional reverse lips 36a, 36b. The reverse lips 36a, b provide for rounded edges 37a, b to prevent cuts on the installer's hand and skin during the installation process while the installer is handling the tubular side bar 14. The reverse lips 36a, 36b may also provide edges 38a, 38b which can grip into the retaining plate 32 so that the tubular side bar 14 does not become loose due to vibration. The reverse lips 36a, 36b are shown as being folded in the upward direction. However, it is also contemplated that the reverse lips 36a, 36b may be folded downward such that the edges 38a, 38b can dig into the support surface 40 of the support plate 30 to prevent loosening of the tubular side bar 14 during vibration caused by the truck. It is also contemplated that the bottom surface 42 of the retaining plate 32 and/or the support surface 40 of the support plate 30 may have a recess 43 that receives the reverse lip 36 to further prevent lateral movement of the tubular side bar 14 in the Z direction 44 as shown in FIGS. 3a and 3b. The tubular side bar 14 is shown as having a hollow interior 46 or fabricated from a steel material that is bent into the shape shown. The hollow interior 46 provides a space for the retaining plate 32 as shown in FIG. 4.

Referring now to FIG. 2a, in an alternate embodiment, the tubular side bar 14 may be fabricated from a tubular material. The elongate channel 15 instead of being a single elongate channel that extends from the first end 24 to the second end 26, the bottom side of the tubular side bar 14 may have a plurality of elongate cutouts 17. The elongate cutouts 17 are defined by medial edge portions 28a, 28b. The medial edge portions 28a, 28b as shown in FIG. 2a may also be formed with the lip 36a, 36b or a reverse lip, as discussed above. The elongate channel 15 allows for the mounting brackets 16 to have a, certain amount of lateral freedom in the X direction but yet still be mountable to the tubular side bar 14 as discussed herein.

The retaining plate 32 may have a flat base portion 48 (see FIG. 4). The base portion 48 may have one or more threaded holes 50 which receive the threaded portions of the bolt 34. The retaining plate 32 may have optional sidewalls 52 that extend upward and protect the threaded holes 50. Instead of threaded holes 50, it is also contemplated that the base portion 48 may have holes that receive the threaded portion of the bolts 34 and that bolts 34 are secured to nuts that rest on the base portion 48 so that the base portion 48 acts as washer. In order to dispose the retaining plate 32 in the hollow interior 46 of the tubular side bar 14, the retaining plate 32 may have a width 54 that is about the same size or less than a gap 56 of the channel 15. The retaining plate 32 may be inserted upward and then turned 90° as shown in FIG. 4. The threaded holes 50 may be positioned so that they can be accessed through the channel 15 from down below. Alternatively, the retaining plate 32 may be inserted from the first and second ends 24, 26 of the tubular side bar 14 in the event that the width 54 of the retaining plate 32 is significantly larger than the gap 56 of the tubular side bar 14. Once the retaining plate 32 is in position, the channel 15 and support plate 30 are aligned to each other. The support plate 30 may be attached to a cantilever beam 58. Also, the support plate 30 may have two elongate holes 60 that match up with the threaded holes 50 in the retaining plate 32. The elongate holes allow minute positioning of the tubular side bar 14 along the Z-axis and also allow some misalignment between the two holes 50. The bolts 34 are inserted through the hole 60, through the channel 15 and engaged to the threaded holes 50. The bolts 34 are tightened to engage the tubular side bar 14 between the retaining plate 32 and the support plate 30 (i.e., mounting brackets 16). Upon assembly, the tubular side bar 14 is secured to the mounting brackets 16 shown in FIG. 5.

The top side of the tubular running board shown in FIG. 1 may have a foot pad 64. The foot pad 64 may be fabricated from anti-skid material that provides protection from slipping even if the foot pad 64 is wet. The foot pad 64 may extend across the longitudinal direction of the tubular side bar 14. Moreover, the foot pad 64 may have raised ridges that can bite into the footwear of a person stepping upon the running board 10 to further mitigate slipping.

The running board 10 is capable of being mounted to the truck 12 by one person. In particular, the running board 10 is componentized so that each component may be mounted one at a time by one person, if necessary. In particular, one or more mounting brackets may be provided for mounting the running board 10. Each of the mounting brackets 16 are individual components. In the embodiment shown in FIG. 1, three mounting brackets 16 are shown. The installer may secure the left mounting brackets 16 to the truck 12 by way of bolt 62 or other attachment means dependent upon the truck or vehicle model. After the left mounting bracket 16 is secured to the truck 12, the middle and right mounting bracket 16 may sequentially be secured to the truck 12. After the mounting brackets 16 are attached to the truck 12, the support plates 30 of the mounting brackets 16 may be level with each other or in alignment with each other. The tubular side bar 14 can be placed on top of the support plates 30 with the channel 15 aligned to the holes 60 formed in the support plates 30. The retaining plates 32 may be inserted into the hollow interior 46 by aligning the lengthwise direction of the retaining plate 32 to the channel 15 as shown in the phantom arrow lines in FIG. 4. The retaining plate 32 may be inserted through the channel 15 and rotated 90° and disposed above hole 60 (see FIG. 4). Once the retaining plate 32 is disposed above the support plate 30, the bolts 34 may be inserted through the holes 60 of the support plate 30, through the channel 15 and threadingly engaged to the holes 50 formed in the retaining plate 32. The retaining plates 32 for the other mounting brackets 16 may also be assembled in likewise fashion. Once all of the retaining plates 32 are loosely attached to the support 30 by way of bolts 34, the X and Z location of the tubular side bar 14 may be adjusted for aesthetics and functional purposes. Once the tubular side bar 14 is aligned, the bolts 34 may be tightened to secure the tubular side bar 14 in place. Anti-rotation material such as LOCTITE may be placed on the threads of the bolts 34 to prevent loosening of the bolts 34 due to vibration.

The running board 10 may also be shipped in a compact box. The mounting plates 16 and retaining plates 30 are disassembled and can be packaged or stacked upon each other. The mounting brackets 30 do not have to be shipped protruding out from the tubular side bar 14 as shown in FIG. 1. Rather, they may be removed from the tubular side bar 14 and transported in a stacked and compact configuration.

The running board 10 disclosed herein was described as being mounted to the side of a truck. However, it is also contemplated that the running board 10 may be mounted to the rear of a vehicle, front side of a vehicle, or as needed. Additional running boards can be mounted to multiple sides (driver and passenger) of the vehicle. The running board 10 may be fabricated to be as long as necessary as the situation may dictate. For example, the running board 10 may be mounted to provide an intermediate step for only the front passengers of a vehicle and not the rear. Also, the running board 10 may be bent at different angles to provide an intermediate step at different elevations as the situation may dictate. One elevation for the front passenger, a different elevation for the back seat passengers. Moreover, although the running board 10 was described as being mounted to a truck, other types of vehicles are also contemplated such as an earth moving vehicle, automobile, etc.

The above description is given by way of example, and not limitation. Given the above disclosure, one skilled in the art could devise variations that are within the scope and spirit of the invention disclosed herein, including various ways of attaching the mounting brackets 16 to the vehicle 12. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for mounting a running board to a vehicle, the running board comprising:
a tubular side bar with a single elongate channel located at an underside of the tubular side bar, the tubular side bar having medial edge portions that define the single elongate channel;
first and second mounting brackets which are attachable to mounting places on the vehicle, the first and second mounting brackets having support pads that define support surfaces alignable to any point along the elongate channel;
first and second retaining plates insertable into an interior of the tubular side bar with the medial edge portions disposed between first and second retaining plates and the support pads of the first and second mounting brackets; and
fasteners attachable to the first and second retaining plates and the first and second mounting brackets by way of the single elongate channel for clamping the medial edge portions of the tubular side bar between the first and second retaining plates and the support pads of the first and second mounting brackets;
wherein the running board can be mounted to trucks with mounting places having different distances since the first and second mounting brackets can be mounted at different mounting points along the single elongate channel of the tubular side bar.

2. The running board of claim 1 further comprising end caps attached to opposed distal ends of the tubular side bar.

3. The running board of claim 1 wherein the fasteners are bolts.

4. The running board of claim 3 wherein the support pads have through holes aligned to threaded holes formed in the retaining plates and aligned to the single elongate channel so that bolts may be fed through the through holes, through the single elongate channel and threadingly engage the threaded holes of the retaining plate.

5. A running board for a vehicle, the running board comprising:
a tubular side bar wherein an underside of the tubular side bar has an elongate channel for accessing an interior of the tubular side bar;
first and second mounting brackets attachable to mounting places of the vehicle, the first mounting bracket attachable to tubular side bar, the second mounting bracket attachable to the tubular side bar along the elongate channel so that a first distance between attachment points of the first and second mounting brackets to the tubular side bar corresponds to a second distance between the mounting places of the vehicle when the running board is mounted to the vehicle;
wherein the running board can be mounted to trucks having different second distances defined by the mounting places since the first and second mounting brackets can be mounted at different mounting points along the single elongate channel of the tubular side bar.

6. The running board of claim 5 further comprising a retaining plate attachable to the second mounting bracket wherein medial edge portions that define the elongate channel are disposed between the second mounting bracket and the retaining plate for securing the tubular side bar to the second mounting bracket.

7. The running board of claim 6 wherein the retaining plate is disposed within the interior of the tubular side bar, and the running board further comprises a bolt for securing the retaining plate to the second mounting bracket.

8. The running board of claim 7 wherein the second mounting bracket further comprises a support surface and the bolt clamps the medial edge portions between the support surface and the retaining plate to frictional engage the tubular side bar to the second mounting bracket.

9. The running board of claim 8 wherein the first mounting bracket is attachable to the tubular side bar along the elongate channel.

10. The running board of claim 9 further comprising first and second retaining plates, the first and second retaining plates attachable to the first and second mounting brackets wherein the medial edge portions of the tubular side bar are disposed between the first and second mounting brackets and the first and second retaining plates for securing the tubular side bar to the first and second mounting brackets.

11. The running board of claim 10 wherein the first and second mounting brackets further comprises first and second support surfaces and medial edge portions that define the channel of the tubular side bar are disposed between the first and second retaining plates and the first and second support surfaces wherein first and second bolts clamp the medial edge portions between the first and second support surfaces and the first and second retaining plates to frictional engage the tubular side bar to the first and second mounting brackets.

12. The running board of claim 11 wherein the first and second support surfaces have recesses for receiving a reversed lip of the medial edge portion.

13. The running board of claim 10 wherein the first and second retaining plates have recesses for receiving a reversed lip of the medial edge portion

14. The running board of claim 5 further comprising friction pads secured to an upperside of the tubular side bar.

15. A method of mounting a running board to a vehicle, the method comprising the steps of:
attaching first and second mounting brackets to mounting places on the vehicle;
laying a tubular side bar on support surfaces of the first and second mounting brackets wherein the support surfaces are aligned along an elongate channel of the tubular side bar;
inserting retaining plates within an interior of the tubular side bar;
aligning the retaining plates to the support surfaces of the first and second mounting brackets;
clamping medial edge portions of the tubular side bar that define an elongate channel of the tubular side bar between the retaining plates and the support surfaces of the first and second mounting brackets to attach the tubular side bar to the first and second mounting brackets.

16. The method of claim 15 wherein the clamping step comprising the step of bolting the first and second mounting brackets to the retaining plate.

17. The method of claim 15 wherein the elongate channel may comprise first and second elongate channels spaced apart to correspond to a distance between mounting places on the vehicle.
